(19) United States
(12) Patent Application Publication
(10) Pub. No.: US 2010/0089845 A1
(43) Pub. Date: Apr. 15, 2010

(54) STORAGE DEVICE FOR VEHICLES

(76) Inventors: Norbert Fässler, Rot a.d. Rot (DE); Wolfgang Schuckel, Aitrach (DE)

Correspondence Address: JACOBSON HOLMAN PLLC, 400 SEVENTH STREET N.W., SUITE 600, WASHINGTON, DC, 20004, US

(21) Appl. No.: 12/451,549

(22) PCT Filed: May 14, 2008
(86) PCT No.: PCT/EP2008/003871

§ 371 Date: Nov. 18, 2009

(30) Foreign Application Priority Data
May 18, 2007 (DE) 10 2007 023 540.4

(51) Int. Cl. E04H 6/18; A47B 57/06; B66F 7/02; B66F 7/04

(52) U.S. Cl. 211/1.57; 414/240

(57) ABSTRACT

The invention refers to a storage device for vehicles, goods or the like with several storage spaces. At least one storage space is located on a lifting or lowering platform. The platform is guided on one or more static pillars, and a motion drive is provided for the platform. The motion drive comprises a moving rod with a traction turning device. Furthermore the motion drive comprises a traction mechanism, and one end of the traction mechanism engages at the platform.

The invention refers to a storage device for vehicles, goods or the like. It has several storage spaces, at least one storage space being arranged on a lifting or lowering platform, the platform being guided on at least one static pillar and a motion drive being provided for the platform.

Storage devices mentioned above are preferably used for increasing the number of available storage spaces, for example in underground garages, garages, parking garages and so on. The advantage of storage devices of this type is that on one and the same basic space not only one vehicle, but two or more vehicles can be parked.

There are concepts where from a higher positioned entrance vehicles are parked on a movable platform, and then the platform is lowered completely downstairs to open above space for another parking facility, as well as concepts where the lowest storage space is at ground level with the entrance, and above of this lowest storage space at least one other movable platform provides parking facilities. The invention basically refers to these different modifications. Mostly the invention relates to parking devices for vehicles, without limiting the field of application to this special case. The subject matter of the invention is basically suited also for being used as a device for storing other goods, it does not matter which type. If, therefore, in the following vehicles are mentioned, this does not restrict the field of application of the invention to it, this has to be understood as an example.

The storage devices for vehicles mentioned before are constructed and manufactured in a great array of types with reference to the respective conditions in the building but also to different stress, different heights of the parked vehicles or other dimensions. The single batch sizes therefore are rather small so that manufacturing is expensive.

Therefore, it is an object of the invention to go on developing the state of the art as described in the beginning, and to design the storage devices as constructions as variably as possible and the manufacturing as economically as possible.

In order to solve this problem the invention comes from a storage device for vehicles or goods or the like as described in the beginning and suggests in a first modification according to the invention that the motion drive has a traction turning device for a traction mechanism on a moving rod, and one end of the traction mechanism engages at the platform, and the traction mechanism has a length compensation element.

The concept suggested here according to the invention employs the principle of a cable pull with the advantage of a “moved roller”. The moving way of the moving rod can be set in any way, so that the result is a high variability in adjusting the lifting height of the platform so that the lifting height can be adjusted simply to the respective conditions. At least it is possible to realise with a design of the motion drive as described a number of different lifting heights so that the number of types is reduced accordingly, and the variability of the storage device is accordingly increased. However, the advantage according to the invention is not solely restricted to that. The motion length of the moving rod is not only an advantage in the setting-up of the storage device, but also in its construction or the production or assembly, it has also to be taken into consideration during operation of the storage device. The concept according to the invention is suitable for the motion length of the moving rod to be changed for example by the user or during maintenance accordingly, when, for example, the heights of the parked vehicles change accordingly.

Furthermore through the changed drive concept of the moving roller (in this case a moving traction turning device) a fast and constantly running drive is provided without the necessity of providing accordingly more complicated motion drives, for example with telescope cylinders and so on, for an accordingly fast lowering or lifting movement. The motion speed of the thus lifted platform is double of the motion speed of the moved traction turning device of the moving rod.

By the employment of the length compensation element according to the invention the effective length of the traction mechanism can be varied accordingly. Preferably the length compensation element is not designed as traction mechanism in order to save costs. Often a plate link chain or the like is used as traction mechanism. However, it has turned out that in certain areas of the storage device the flexibility of the traction mechanism is not of value as this flexibility is not used in certain sections. For that purpose then in the alternative according to the invention a length compensation element is used which is connected with the traction mechanism. If, for example, the storage heights or the final positions of the shifting platforms change the result will be an accordingly altered position of the traction mechanism which is compensated by a suitable adjustment of the length compensation element.

Cleverly here the length compensation element is in the end area of the traction mechanism and connects the traction mechanism, for example, with a suitable bearing of the traction mechanism at the storage device or the base or the wall or the supporting base of the building surrounding the storage device.

Besides the employment of a plate link chain as traction mechanism it has, of course, to be taken into consideration that, according to the invention, each and every traction mechanism can be employed here. As the traction mechanism has often to be guided across a traction turning device a suitable flexibility or bending is an advantage so that as traction mechanism in particular, besides plate link chains or other chains, also wire cables, ropes and the like are suitable according to the invention.

Furthermore, the problem according to the invention is solved by arranging a compensation traction mechanism in particular below the platforms between the two static pillars, the first end of the compensation traction element being arranged on the first static pillar and the second end of the compensation traction element being arranged on the second static pillar and the compensation traction element being deviated by deviations arranged on the platform, a static pillar having a number of connecting points for the compensation traction element, and by selecting the connecting point the width of the platform can be adjusted while the total length of the compensation traction mechanism remains the same.

By this solution according to the invention a high variability in the realisation of platforms with differing width with the storage device according to the invention is provided. The compensation traction elements can be prepared in large batches with a constant length, and then, according to the actually realised width of the platform can be put in different connecting points on the static pillar. As the compensation traction element extends diagonally below the platform the width of the platform directly influences the length of the compensation traction element which always has to be adapted according to the state of the art.

By the suggestion according to the invention that a number of connecting points on the static pillar is provided for the compensation traction element, it is achieved that during the production of the compensation traction element or the static pillar the actual width of the platform is not decisive, this is considered in the selection of the suitable connecting point, depending on the actual width of the platform.

In addition to that the problem according to the invention as described in the beginning is also solved by providing a base of the static pillar which may be, if necessary, exchanged and which is arranged on the static pillar as a component independent from the static pillar.

In the solution according to the state of the art the base of the static pillar is always designed in one piece fixedly with the static pillar. However, often the selection of the base of the pillar depends on the actual conditions of the bottom on site. The variability of the storage device according to the invention is therefore considerably increased when the static pillar is designed as component separated from the base of the static pillar, and several bases of the pillar, similar to a modular concept can be connected with static pillars prefabricated on larger batches.

The solutions according to the state of the art include a one-piece connection of static pillar with base of the pillar (for example welded), which is inconvenient for transporting as these modifications require a large space for storing or a large transport volume. By the solution according to the invention, however, not only a modular concept is realised for the static pillar, which can be adapted on short notice to the respective conditions, also the expenses for transport are clearly lower as the expansive design of the static pillar/base of static pillar-combination is not necessary before the actual setting-up of the storage device according to the invention, this, however, can be transported very space-saving.

The single before-mentioned measurements solve the problem mentioned in the beginning in a convincing way. The employment of a length compensation element makes it possible to realise with a storage device according to the invention a number of different platform distances, this advantage being double, namely first of all during setting-up the storage device according to the invention where only shortly before the actual assembly it has to be defined which height or which type is required. But also during operation of the storage device according to the invention then the distance of the single platforms can be adapted to different heights of vehicles without any problems without the requirement of a completely new storage device. Increasing the flexibility and the comfort of use comes surprisingly with a reduction of the storing expenses as a larger size of batches of the single elements can be produced and thus the producing cost, but also the storing cost for that are smaller. As finally with one type of the storage device according to the invention a number of different types according to the state of the art can be covered, components rarely used, but then to be provided on short notice do not have to be supplied. It has to be taken into consideration here that increasing the comfort in setting-up as well as during application, that is in use, of the storage device according to the invention usually does not come with a reduction of the number of types, but the producing cost is usually increased. Exactly that is avoided by the invention.

In addition to that the problem according to the invention of a storage device for vehicles, goods or the like is solved by providing a plate link chain as traction mechanism interacting with the motion drive and/or compensating traction element extending, in particular, below the platform and ending at the static pillar, the plate link chain consisting of a number of chain links each being connected jointly to another by pins and each chain link having between one and nine plates, preferably between four and eight plates.

Cleverly for different traction tasks in the storage device according to the invention also a uniformly designed traction element as traction mechanism or compensation traction element is provided. It has to be taken into consideration here that the platform has a minimum carrying power of 19 kn (this is about 2,000 kg). However, as the platforms are also provided for vehicles or goods which may be clearly heavier cleverly the traction element is designed in such a way that it can also comply with these increased requirements without any problems and also fulfils them. The traction element therefore has actually also sufficient stability to manage a travelling load of more than 25 kn without any problems and to fulfil these requirements. The traction element therefore has also sufficient stability to be able to carry and hold a travelling load of more than 25 kn. Accordingly such a traction element then has a clearly higher minimum breakage force.

It has turned out here that a plate link chain having plate links each connected to another by pins and each chain link having between one and nine plates, preferably between four and eight plates complies with these requirements, a corresponding advantage in producing being reached by the employment of an accordingly designed plate link chain, as it is also claimed according to the invention, for example as compensating traction element. If namely the storage device according to the invention is enlarged and in particular the minimum carrying force of the platform is increased the accordingly designed plate link chain is already suitable for that and does not have to be exchanged additionally.

Cleverly not all employed traction elements, that is traction mechanisms and traction compensation elements, have to be identical, the effect according to the invention is already reached if one of these traction elements is designed as described.

By using an identical traction element as traction mechanism and compensation element, of course the producing cost for this traction element, which is designed as described as plate link chain, is lowered accordingly as then this plate link chain can be supplied in larger batches. Of course, also storing and the spare part management are accordingly made simpler.

The invention here does not only comprise a storage device as described in the beginning, but it also comprises a plate link chain, in particular for use as traction mechanism and/or as compensation traction element in a storage device for vehicles, goods or the like. The plate link chain here consists of a number of chain links each connected jointly to another by pins, the plate link chain having at least four plates per chain link and a breakage power of at least 60 kn, preferably at least 100 kn. A plate link chain designed this way is in particular characterised in that it can be set in variably in before-mentioned storage devices and that it can be used because of the high breakage power of the plate link chain either as compensation traction element and/or as traction mechanism. The breakage power, of course, of course corresponds with the carrying force of the platform as well as its own weight in a certain safety relation.

Often for storage devices for vehicles a minimum breakage power of 100 kn for the loading capacity of the platform of up to 2 t (corresponds roughly with 20 kn) are seen as sufficient. However, it is also possible, for example by a lighter construction of the platform, to get to a lower minimum breakage power.

The pre-mentioned objects according to the invention are described in the description each as inventions of their own. However, this does not exclude their common employment in a storage device according to the invention.

In a preferred embodiment of the invention it is provided that by changing the effective length of the length compensation element the final position of the lifted platform can be adjusted to the level of the good to be deposited on the platform, for example the vehicle. The adjustment range of the length compensation element is far more than for example 1.5 or 10 cm, it comprises several times the height or thickness of the platform. The length compensation element must not be confused with an adjustment device for a tight fit of the chain guided across the moving roller, where a correspondingly large adjusting range is not possible. By means of the length compensation element suggested according to the invention it is achieved that the final position of the lifted platform varies about 10 cm and can be adjusted.

An essential advantage of the invention is the fact that in a modification at the static pillar a releasable locking unit is provided which effects that the platform independently from the motion drive or traction mechanism remains in a desired locking position at the static pillar. First of all, the locking device suggested here has the purpose of safety. In the case that the motion drive, that is for example a hydraulic cylinder or its drive, fails, or the traction mechanism, for example a plate link chain or the like, breaks an uncontrolled fall of the vehicle parked on the platform is not probable as then the locking device suggested according to the invention is in operation.

In a preferred embodiment of the invention it is furthermore suggested that each final position of the lifted platform defined by the change of the effective length of the length compensation element corresponds also with a locking position of the locking device. As the locking device is arranged anyway for safety purposes across a larger height area at the static pillar thus, of course, also in larger interval suitable locking positions are offered in the possible final positions of the platform. The locking device thus provided anyway which otherwise in these positions has to work only as an aid, namely if during the motion a corresponding default occurs, is used additionally without further effort by the suggestion according to the invention.

In another modification according to the invention it is suggested that the storage device, in particular the storage device in use the lifted platform of which is in a first final position can be brought in a second, new (upper) final position by changing the effective length of the length compensation element, the platform being able to be loaded each time in both final positions. It is an advantage of the invention that the storage device according to the invention is highly variable even during operation (not only during assembly), that is in use (however unloaded), with reference to the distances of the platforms, that is the available platform distances or their final positions. The storage device can be adjusted, for example by the user, to the respectively adjusting vehicle height. The adjusting operation itself is carried out preferably in unloaded condition. The two final positions differ, for example, by about 10 cm, however, these may also be only 2 cm. The difference of the final positions may vary therefore, for example, between 2 cm and 20 cm, preferably between 5 cm and 15 cm, a modular dimension of 10 cm in this area has turned out convenient.

In a preferred embodiment of the invention it is provided that the lowest storage space is arranged below the lowest movable platform. In this modification according to the invention a very simple storage device according to the invention is the result. For the lowest storage space not a separate platform is used, but for example the floor plate on which the storage device is set up. It has, of course, to be taken into consideration that a vehicle on the lifted platform is not available before the vehicle below it is removed. If necessary, however this can be monitored by means of a suitable monitoring unit.

Alternatively to that it has, of course, to be taken into consideration that also on the lowest storage space a platform can be provided, for example if the underground is not ready to drive on. This platform is then for example fixed, that is it cannot be lifted.

Of course it has to be taken into consideration that the invention comprises also such storage devices where the lowest storage space is on a platform arranged moving. Such a modification can be provided, for example, in pits and so on where lifting the lowest platform provides a possibility for connecting with the entrance serving for several platforms and being located above the lowest storage space.

Cleverly it is according to the invention provided that the storage spaces are arranged one above the other. Cleverly here the platforms are guided one above the other on a common spot so that the static conditions are accordingly simpler. Besides this basic arrangement of the storage spaces one above the other it is, of course, also possible to provide two or more storage spaces, for example on an accordingly larger platform, one beside the other. Such an arrangement also is comprised by the solution of the invention.

Preferably the platform comprises a sliding element, the sliding element being guided on the static pillar and the traction mechanism engaging on the sliding element. The sliding element has the purpose to slide sledge-like on the static pillar serving as guide. For that the platform has to be guided on the static pillar. The guides used for that are generally known. By arranging the traction mechanism on the sliding element the lifting force is guided as close as possible at the bearing point of the platform on the static pillar in this and the risk of tilting or jamming is reduced considerably. Furthermore, the sliding element connects on the side to the platform and a connection of the platform with the traction mechanism via the sliding element just in this lateral area does not disturb in any way the free entrance or the travelling of the platform.

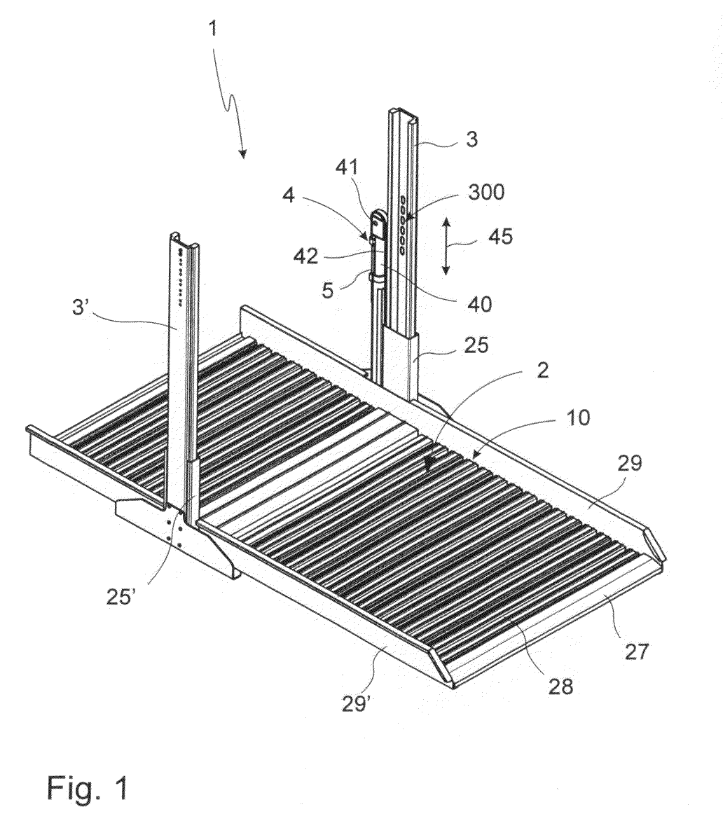

In order to comply with the static requirements it is provided here that the sliding element, if necessary, may be clearly longer than the height of the cheek or the side beam in order to reach a guide of the platform on the static pillar as stable as possible. Therefore the sliding element projects sleeve-like or semi sleeve-like on the side upwards beyond the platform. This can be seen in particular in FIG. 1 and is described there again.

It turned out very convenient for the invention that as motion drive a preferably hydraulically acting working cylinder is provided the piston rod of which serves as moving rod. Hydraulically acting working cylinders are known sufficiently as means of drive or lifting. They come in a large variety of types and the technique can be managed easily. They serve for the invention as ideal motion drive as they are suited for providing sufficient lifting forces for lifting platform(s) loaded with one or two vehicles.

According to the invention it is provided here that the piston rod of the hydraulically acting working cylinder or other cylinder alternatively also acts on another rod.

The invention furthermore provides that as motion drive a spindle drive with a motor, in particular an electro-motor, is provided. A spindle is here provided moving in longitudinal direction and the motor, which is stationary, drives a nut because of which the spindle shifts axially. Here according to the invention, for example, an area of the spindle or even the entire spindle may serve as moving rod, or the spindle acts on a moving rod designed as separate component.

Basically, however, the invention can be realised also with a, for example, pneumatically acting working cylinder or even with a ball roller spindle or a steering rack drive or a linear drive. Advantageously the drives are designed in such a way that a moving rod is provided via which the lifting force is transferred to the platform by means of the traction mechanism.

In a preferred embodiment of the invention it is provided that the traction turning device is designed as rotating roller. The use of a rotating roller as traction turning device is known as soft running and economical. The diameter of the roller is cleverly chosen just so that a tight fit of the traction mechanism at the traction turning device is guaranteed as best as possible. According to the invention it is in particular suggested that as traction mechanism a plate link chain is employed. The diameter of the rotating roller is defined in this case of application by the dimensions of the chain, that is its division and thickness. Cleverly the diameter is chosen here not too small so that instead of a rolling motion not a sliding at the roller results which may lead to an increased wear at the roller and possibly also at the chain.

Cleverly it is taken into consideration here that all traction turning devices or elements are constructed as identically as possible as the traction elements (this may be the traction mechanism or the compensation traction element), that means they have the same diameter and also the same width in order to increase the batch sizes accordingly and to reduce storing of the spare parts.

The consequence of this is that in a modification according to the invention the deviation mechanism is a deflection pulley. The deviation mechanism is positioned preferably on both sides at the respective sides of the platform and effects a turning of the compensation traction element from the vertical line to the horizontal line, or from the horizontal line to the vertical line.

As particularly convenient the following modification according to the invention has turned out. According to that a diameter of the deflection pulley is suggested to be 50 mm to mm, preferably 55 mm to 65 mm. The requirements of the deflection pulley, and in the same way also of the rotating roller as traction turning device, are accordingly high. It has to be taken into consideration that at the respective deviation mechanism a considerable force is applied and the roller bearing is loaded accordingly. A sufficiently easy rotation of the roller has to be guaranteed, however, at the same time the roller or the deflection pulley must not be too large so that these can be built in, in particular still in the margin area of the platform, if possible non-visible. Here, of course, the diameter of the deflection pulley also depends on the geometric data of the traction mechanism designed as plate link chain. In the defined diameter interval of 50 mm to 75 mm for the deflection pulley or also the roller, however, satisfying results have been achieved. The result here was in particular that another restriction to 55 mm to 65 mm for the diameter of the deflection pulley or roller is a very good compromise between the rolling qualities and the space requirements of the entire deviation mechanism at the platform.

As far as in this connection a diameter of the deflection pulley or the roller is mentioned this refers to the exterior diameter or the active diameter, that is the diameter of the surface area limiting the deflection pulley at its contact surface.

As the deflection roller interacts with the traction mechanism, in particular the plate link chain, the result according to the plate link chain of the invention has been that a division of the chain links of at least 13 mm, preferably 14 to 17 mm, in particular of 15.6 to 16 mm has proved very conveniently. As division is here seen the distance of the pins connecting the individual chain links flexibly with one another. In particular the fact has to be taken into focus that the plate link chain according to the invention has in the special range of application a high breakage force of at least 60 kn, preferably at least 100 kn or even 150 kn and more. This very high tensile force has of course be received by a suitable material in the chain and the design of the chain, on the other hand the production of the chain has to remain simple, that means, if possible, a production of the chain by machines has to be carried out, and, of course, the use of the plate link chain remains possible in the special case of application, that means the deflection radii or deflection diameters remain sufficiently small, so that there are not space-consuming deflection mechanisms required. In this special case of application plate link chains have proved their excellence whose division of the links is at least 13 mm, where in particular in the interval of 14 to 17 mm for the mentioned application case very good results have been reached. Just in the particularly preferred interval of 15.6 to 16 mm for the division of the links in the interaction with the preferred diameter of the deflection roller or the roller of 50 to 75 mm, in particular of 55 mm to 65 mm an effectively interacting system has been realised.

According to the invention the result is furthermore that the ratio of diameter of the deflection roller to the division of the chain is less than 5, in particular less than 4.7, preferably between 3.5 and 4. In the given range of ratios the result is an optimal load of the chain in relation to the deflection via the roller, while the diameters of the roller are sufficiently small.

In another design according to the invention it is suggested that the plate link chain has a thickness of at least 11 mm, preferably of 12 mm to 18 mm, in particular of 14.8 to 15.3 mm. Besides the size of the single links, which is defined by the division, the maximum breakage force of the plate link chain is determined also with regard to the width of the single plates or even the thickness of the chain or the single plates. The result has been here that, for the application case, in particular in a storage device according to the invention, the thickness of the chain is at least 11 mm, preferably 12 mm to 18 mm. Surprisingly, however, in the particularly preferred interval of 14.8 mm to 15.3 mm a constitution has resulted which can still be employed for the necessary deflection and otherwise has a sufficiently high breakage force and carrying force. It has to be taken into consideration here that also a too thick chain does not guarantee anymore a reliable transmission of power with too small radii and it might be that a one-sided load of the chain is the result and the trend for breaking rises accordingly.

In this connection it has proved conveniently that the ratio of diameter of the deflection roller to the thickness of the chain is less than 6, in particular less than 5.5, preferably within the interval of 3.7 to 4.3.

Besides the respective dimensions of the single plates of the chain or the chain link, which is defined by the division and the thickness of the chain or the plates, of course, also the pin connecting the single chain links to each other is important for the question of stability of the plate link chain according to the invention. In the application case discussed here, where a plate link chain with a breakage force of at least 60 kn, preferably at least 100 kn is provided, and is defined in particular in the connection with the other geometric data of the plate link chain or the ratios to the circumference of the roller, the result for the thickness of the bolt is a value of at least 4.5 mm, preferably of 5 mm to mm. In particular a modification has been proved to be convenient where the diameter of the bolt is from 5.8 mm to 6.2 mm in interaction with the thickness of the chain of 14.8 mm to 15.3 mm, as here an optimum of flexibility, bending and load and overall thickness of the chain is realised, and in particular the use of the plate link chain in the concerned range of load is satisfying to the highest degree.

The result is according to a modification of the invention, a ratio of the thickness of the chain to the diameter of the pin of at least 2.4, in particular of 2.41 to 2.7, preferably 2.47 to 2.60.

An essential advantage of the invention is the fact that in particular the storage device according to the invention is designed very variably to provide with a number of components as small as possible, which can be, however, employed very flexibly, a large number of types while at the same time the single elements have a large batch size. Here in particular the adjustment of the lifting height of the platform by the motion drive is interesting as the lifting height cannot only be adjusted during the first assembly, but, it can be varied, if necessary, also later during operation by the users, if for example, during winter time a convertible with less height is parked on the upper platform and on the bottom a higher van is parked, and this use is reversed in the summer time. Therefore it is not only important here to provide a variability as high as possible when assembling the storage device according to the invention, in order to keep the production costs as low as possible, it is also another decisive part of the invention to keep the storage device also during use as variable as possible in order to adjust it very simple to the different ranges and objects of use.

It has turned out here very convenient that in a modification according to the invention a limiting device is provided for the motion length of the moving rod. The lifting height of the moving rod, in particular when it is realised for example as piston rod of a working cylinder, gets a certain adjustment or limiting or restriction by means of the limiting device suggested according to the invention. The design of this limiting device is very variable and has many modifications.

In a first modification according to the invention it is provided here, for example, that the limiting device defines at least one end of the movement of the moving rod. Depending on the dimension of the motion drive this may be the upper or lower position of the moving rod. It is, of course, possible that both ends, that means the upper and the lower one, are used for limiting the movement of the moving rod. By a suitable arrangement of the end, of course, also the entire motion length of the moving rod is limited and set.

It is a particular advantage of the invention that the limiting device can easily be operated even during operation, and, if necessary, can also be operated without suitable maintenance or serving expenses by the users themselves in a reliable and safe way. This is also provided for in the frame of the large number of modifications of the limiting device, and therefore a very user-friendly realisation and a large variability of the resulting storage device according to the invention is possible.

For this reason the invention also has an adjustable limiting device through which the moving length or the position of the end or the ends can be set.

In a first modification of the invention it is provided that the limiting device is designed as a stop for the rod the position or length of which can be in particular be changed. The movement of the moving rod is monitored by a suitable control. If the rod travels toward a corresponding stop, that means the space of movement of the rod is limited by a stop, this is discovered by a suitable power-path monitoring, and then the motion drive is switched off as another movement, although further energy is invested in the motion drive, is not carried out. This can be realised, for example, by suitable manometric switches in a hydraulic solution or with contact switches at the stop. It is clear that by the position of the stop the end and/or the effective length, that is the length of movement, can be set. The use of a stop is possible here for the upper as well as for the lower end, if necessary then for that two respectively separated stops are provided, or a stop rail is employed which has a stop each for the upper and the lower end. Besides a purely manual design, of course, also a corresponding automatic concept is possible where electric actuating drives position the stops accordingly and then keep them at their desired positions.

Alternatively to that it is provided in another modification according to the invention that the limiting device is designed as a sleeve slid on the rod. According to the invention at least one sleeve is provided, of course also a complete adjusting set of sleeves can be used in order to realise different heights or end positions. Such a design of the limiting device is an advantage in particular for the lower end, that is for the driven back or pulled back rod.

If necessary the length or position is realised by several sleeves of identical or different height one above the other or with a kit of sleeves of different heights.

According to the invention it is provided as a means for influencing the ends or the length of movement of the moving rod, to set the position of the traction turning device at the rod. For example, the moving rod, for example a piston rod, has a threaded rod the position or effective length of which can be altered, which is guided in a suitable boring of the rod equipped with a thread, and the rod carries on its front end the traction turning device. By a suitable extension or shortening of the active length of this threaded rod the relative position of the traction turning device at the rod can change, and thus the position of the end or the length of movement of the moved or moving rod can be influenced.

Thus according to the invention the result is a modification where also the limiting device acts on the position of the traction turning device, and thus increases the variability of a storage device designed accordingly.

Preferably according to the invention a manually adjustable or operating limiting device is provided. The realisation as manually adjustable limiting device has the advantage that it can be realised easily in mechanical respect and is nevertheless very reliable.

Alternatively to the limiting device which can be adjusted manually according to the invention it is suggested furthermore that the limiting device has an (e.g. electric) actuating drive which can be positioned at selected positions. In such a design, supported for example by an electro-motor, the desired position is chosen and then the actuating drive which, for example, carries the stop is positioned automatically and thus a corresponding limitation or change of the length of movement of the moving rod is reached.

It has already been explained that it is convenient that the traction mechanism is connected with the length compensation element. It is convenient here that the length compensation element is not flexible, as this is, as a rule, not necessary in the case of application provided here. Conveniently, however, the traction mechanism is connected flexibly with the length compensation element in order to be able to use the complete length of the traction mechanism which is actually flexible or movable, for a deviation, for example around a deviation and so on.

According to the invention it is provided that the length compensation element is supported on bearings on the static pillar, on the floor or a wall or the stationary part of the motion drive (for example on the cylinder of the working cylinder). For a degree of pre-fabrication as high as possible it is convenient if the length compensation element is supported on an element of the storage device itself, for which purpose it is convenient that the length compensation element is supported on the static pillar or another stationary part of the storage device, such as for example of the motion drive. Alternatively it is, of course, possible to attach the length compensation element to the floor on which the storage device is set up or to a wall next to the storage device. Such a support may require more work as a separate anchoring for the length compensation has to be provided, however, it is possible. In particular, by such an arrangement the availability of the length compensation element can be changed or improved, which is interesting just with constructions in pits and so on.

Furthermore it is suggested according to the invention that the length compensation element is supported on bearings on the base of the static pillar. Such a design also makes a suitable pre-fabricating possible and in particular uses the space at an optimum.

In a preferred modification of the invention it is cleverly suggested that the motion drive, in particular the working cylinder, is supported on the base of the static pillar. In this way also a correspondingly convenient pre-fabricating is possible, assembly is made easier. In a preferred embodiment of the invention it is suggested here that a distance as small as possible of the length compensation element supported on bearings on the base of the static pillar and the motion drive supported at the base of the static pillar is provided. If necessary, the base of the static pillar has in the area of the support of the motion drive or the support on bearings of the length compensation element a suitable reinforcement. As the occurring forces are considerable, of course by a suitable short distance the bending moments are limited. A suitable reinforcement can be, for example, welded on as iron or steel element on the base of the static pillar consisting of iron or steel.

In a preferred embodiment of the invention the length compensation element is provided as turnbuckle. The turnbuckle here consists for example of a tapped bush with threaded bolts screwed in on an end. Turnbuckles are sufficiently known as structural components and available as standardised component in a large variety of lengths (20 cm to 80 cm) with sufficient breaking strength. A considerable advantage when employing turnbuckles is in the invention in particular the fact that there is a large range of adjustment because of the length or the height of the tapered bush and, because of the drive of the thread a rather exact adjustment is possible. The turnbuckle can also be operated easily for adjustments.

It is convenient that the length compensation element has a length adjustment device through which the effective length of the essentially actually rigidly designed length compensation element can be precisely adjusted.

According to the invention it is provided here that the length compensation element is designed rigidly itself, in particular rod-like or the like, and is cut to lengths for example from a suitable rod material and so on. The material, of course, has sufficient stability which exceeds, if possible, the stability of the traction mechanism connected with length compensation element, in order to safely prevent the length compensation element from breaking. Therefore the typical materials are used for that, such as for example iron, steel and so on.

In a modification according to the invention it is provided that the length compensation element is designed as threaded rod and a nut the position of which can be changed on the threaded rod is the length adjustment. This is a very simple, however, at the same time efficient possibility of realising the length adjustment device suggested according to the invention. In particular a high precision can be realised as turning the nut on the threaded rod can be carried out continuously and thus each necessary measure or length of the length compensation element can be realised.

In another modification according to the invention it is provided that the length compensation element is designed as catch rod, the catch rod having a number of catches which can be connected fixedly with a bearing stationary with regard to the device in the desired position.

In contrast to the modification mentioned before this modification has only one partitioning in a few predefined catches, this, of course, can be supported by an accordingly shortly designed special precision adjustment, for example by an element which can be turned like a threaded rod or the like. Cleverly here the distances of the catches are chosen such that the desired changes of the lifting heights of the platform are considered.

Similar to the design of the limiting device, which is realised manually as well as supported by a motor or automatically, also a length adjustment device supported by an actuating drive is suggested according to the invention. Cleverly then, for example, a coupling of the control of the two actuating drives (of the length adjustment device and of the limiting device) can be provided with a selection procedure in order to change and define these two parameters accordingly.

In another modification according to the invention it has been suggested that the first end of the compensation traction element is arranged at the first static pillar, the center part of the compensation traction element extends crossly to the platform, and the second end of the compensation traction element ends at the second static pillar. Cleverly the first end of the compensation traction element is arranged in the upper area of the first static pillar, preferably above the lifted position of the platform. The compensation traction element has the object of providing synchronism of the platform between the two static pillars. The length of the compensation traction element is not changed here, however, the compensation traction element is guided Z-shaped or double-L-shaped (bent in opposite directions) below the platform. Because of the use of this compensation traction element a separate synchronous guide at the second static pillar, where as a rule no drive is provided (in particular for economical reasons), is saved. The arrangement suggested according to the invention achieves that jamming or tilting of the platform, in particular in the area of the first static pillar is prevented, as by the constant overall length of the compensation traction element, but the variable sections at the first or second static pillar (the length below the platform does actually not change) the movement of the platform at the second static pillar (where usually also the motion drive is located) is transferred to the movement of the platform at the first static pillar.

As the first end is above the platform, in particular above the lifted position of the platform, the compensation traction element receives at least part of the load on the platform, and transfers it directly in the static pillar. Therefore it is convenient to arrange this bearing point on the side of the platform opposite the motion drive. The static concept becomes here very simple with such a storage device designed according to the invention, the production costs of a storage device according to the invention are low.

Because of the very good access of the first end of the compensation traction element, which is conveniently always above the platform, here also the connecting spots are provided at the first static pillar by means of which it is achieved that, when the length of the compensation traction element is constant (for example as part of a larger batch of plate link chains with identical length), even different widths of the platforms can be realised with the same static pillars and also the same other elements of the drive. If a somewhat wider platform is realised a connecting spot has to be selected which is farther downward, with a narrower platform a connecting spot farther upward is used.

It has already been mentioned that it is clever that the traction mechanism engages in the area of the guide of the platform in the second static pillar at the platform. The compensation traction element serves for synchronism of the movement in the area of the first static pillar, where indeed a traction mechanism engages only one-sided, the suggestion according to the invention does not result in tilting or jamming of the platforms at the two static pillars serving as guides.

Therefore it is also suggested according to the invention that the second end of the compensation traction element is connected in the lower area of the second static pillar with the second static pillar. The adjustment here is not decisive anymore as the good access is provided on the first static pillar according to the invention.

Furthermore it is suggested according to the invention in a modification that along the static pillar a locking catch is provided in which a locking element of the locking device engages in a holding way. Also such a design can be realised simply but efficiently.

Cleverly here it is furthermore provided that the locking device is formed by a channel of punched holes in the static pillar in which an operable locking ratchet engages. The arrangement is here chosen in such a way that the ratchet rises, for example for lifting the platform from catch to catch, that is from hole to hole along the channel of punched holes on its own, however, in the case that there is a problem with the motion drive or the chain breaks, the ratchet engages fixedly in the respective hole and holds the platform in the locking position. For a controlled lowering the ratchet has, of course, to be operated accordingly, that is be pulled back so that the locking function is deleted. This is carried out, for example, by an accordingly monitored drive, for example an electromagnet which, without electricity, puts the ratchet in the channel of punched holes and only pulls it back when electrified. For that, however, other concepts are also possible.

Another advantage of the invention is the fact that at the static pillar a base of the pillar is provided as from the static pillar independent component. By that the invention achieves that the storage device can be used variably for the construction on very different bases, ground slabs, surfaces and so on, without the necessity to supply the complete static pillar according to the different modifications. Cleverly here for the connection of the static pillar with the base of the static pillar a simple or multiple screw connection is provided in order to guide the forces occurring in the static pillar reliably in the base.

In this field the invention has a module concept. A static pillar produced in larger batch sizes can here be connected with two or four different modifications of bases of a static pillar via the simple or multiple screw connection, cleverly the stability of the arrangement being increased by the fact that a positive interlocking of static pillar and base of the static pillar is provided in assembled condition of static pillar and base of the static pillar. This is reached by suitable undercuts or receivers either directly at the base of the static pillar and/or the static pillar through which corresponding twisting or tilting forces are guided not only through the screw connection but also additionally through the positive interlocking elements from the static pillar in the base of the static pillar.

Depending on the field of application the invention provides an essentially symmetric or even asymmetric construction of the base of the static pillar. A symmetric construction makes it possible to realise a rather small base of the pillar which then is screwed fixedly for example by suitable anchoring elements, such as screw anchors and so on, in the ground slab on which the storage device should be set up. By an asymmetric construction of the base of the static pillar, the longer area of the base of the static pillar being arranged in the direction of the entering area of the platform at the pillar, also a storage device which itself is loaded can be realised. An additional anchorage in the ground is then no more (compulsorily) decisive. Of course, it is possible to mix both modifications accordingly with each other.

Cleverly it is provided that the base of the static pillar has fastening openings in order to put through fastening means such as screw anchors, screws, pegs and so on for fastening at the ground.

In another embodiment of the invention it is provided that both opposing static pillars carrying the platform and the sliding elements moving on it are identical. During the dimensioning of the storage device according to the invention it has been considered to cover all modifications or a number of modifications, but also cases of application and employment, with a number as small as possible of structural components. Thus the arrangement is chosen in particular such that the static pillars facing each other and which are, for example, C-shaped are designed identically. The same goes also for the sliding elements shifting on the static pillars which, on the one hand, have to interact with the working cylinder, and, on the other hand, have only the task of a slide. An arrangement has been found here as it is, for example, also described in the drawing, which can be used very universally leading to accordingly larger batch pieces and to an economic production.

The invention claims protection for each combination of the characteristics of this application. This means that protection is also claimed for a combination of characteristics which is different or broader than the present formulation of claims. It is in particular reserved that for such subject matters an independent application can be separated where then the combination of characteristics can be chosen freely in the frame of this disclosure without the restriction to the formulation of claims. It is in particular reserved that subject matters are separated for an independent protection which comprise only parts of the independent claim as well as characteristics of dependent claims. Those solutions are also independent inventions.

In the drawing the invention is shown schematically. In the drawings:

FIG. 1 in a three-dimensional view a modification of the storage device according to the invention,

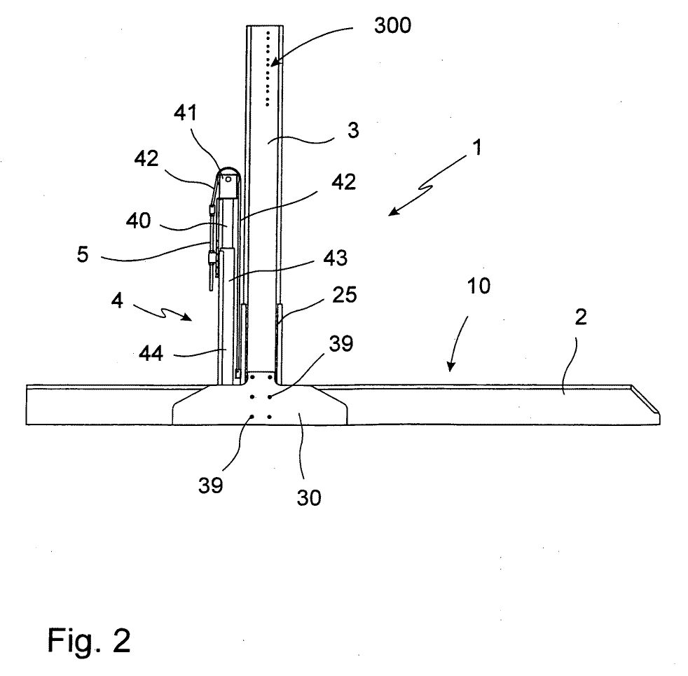

FIG. 2 in a side view the storage device according to the invention,

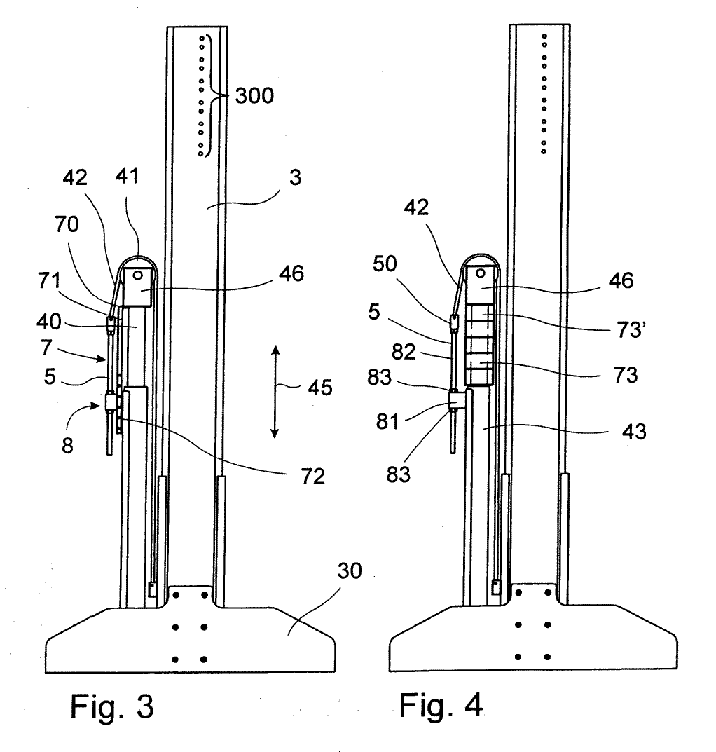

FIGS. 3 to 8 several embodiments of the static pillar of the storage device according to the invention in a side view,

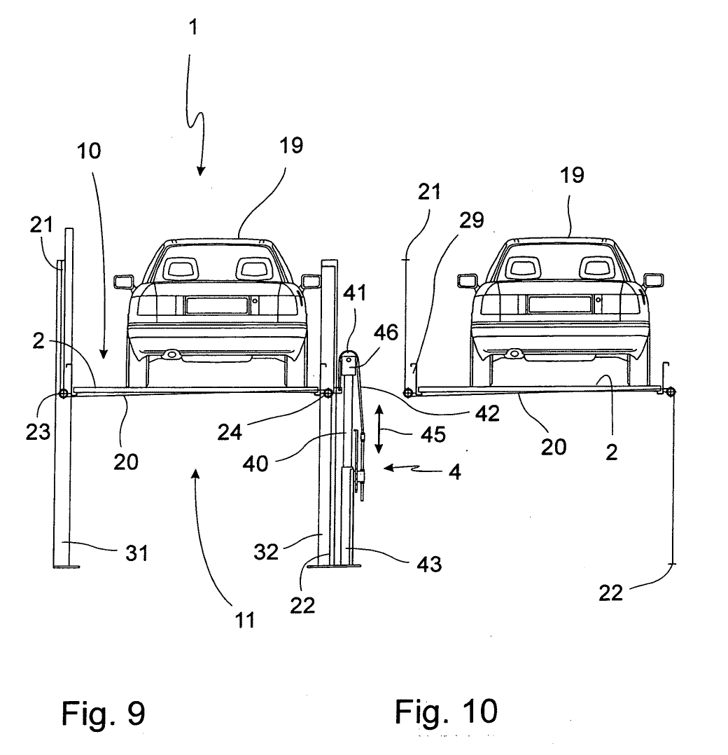

FIG. 9 in a view a storage device according to the invention in use with a vehicle parked on a platform,

FIG. 10 a simplified view according to FIG. 9,

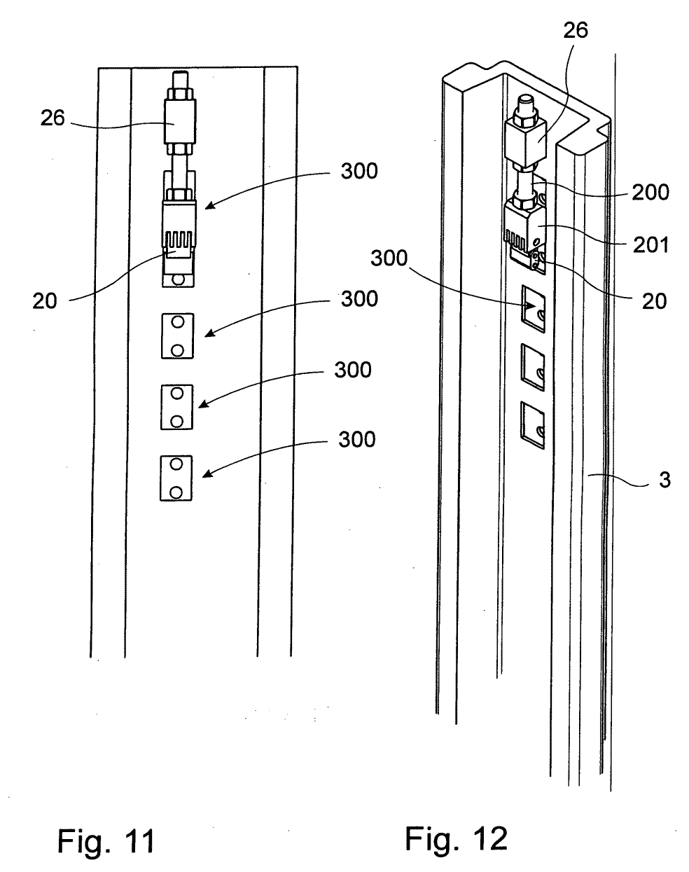

FIGS. 11, 12 a detail of the static pillar of the storage device according to the invention in a view (FIG. 11) or in a three-dimensional view (FIG. 12),

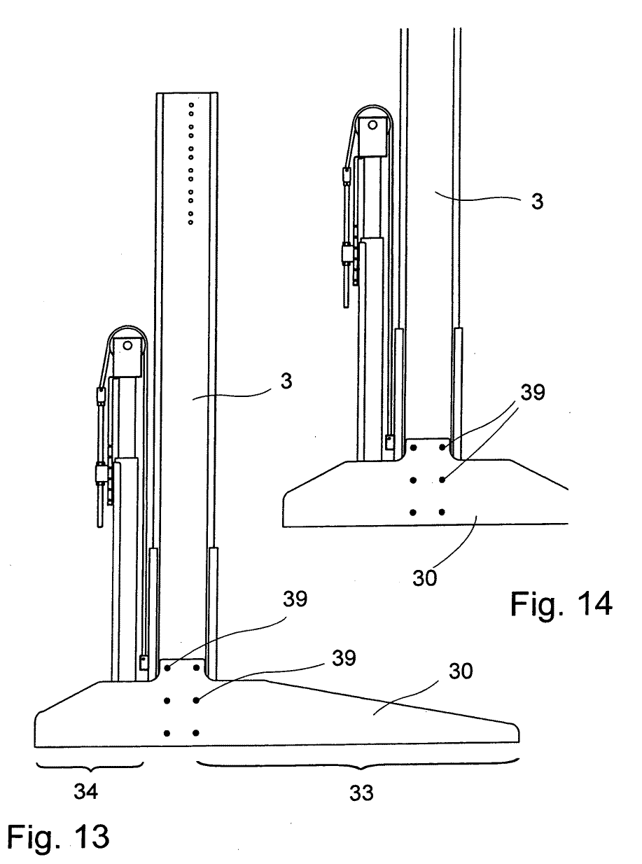

FIGS. 13, 14 each in a view a detail of the base of the static pillar with the static pillar of a storage device according to the invention,

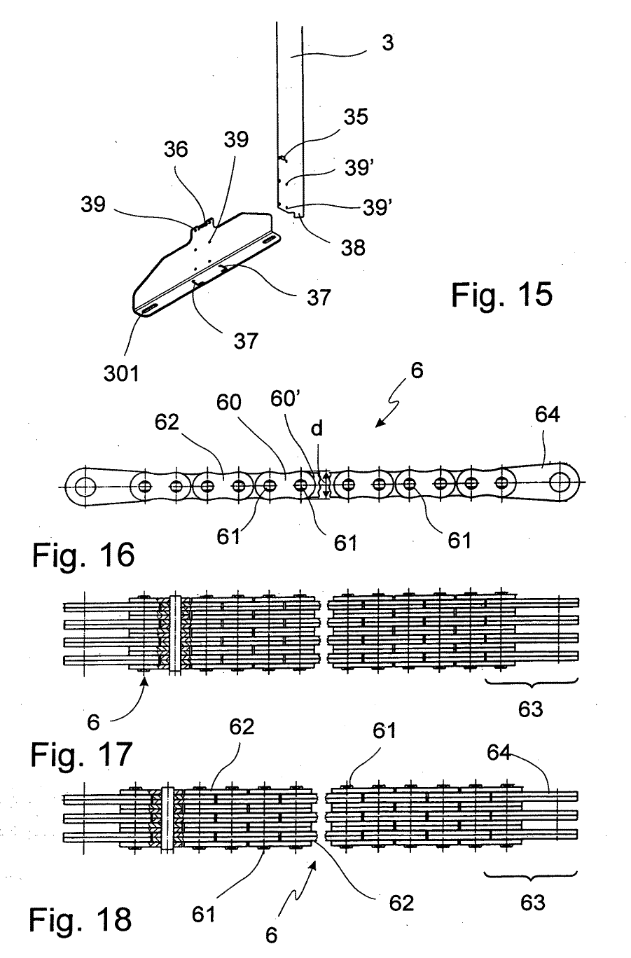

FIG. 15 in a three-dimensional view the static pillar separated from the base of the static pillar according to the invention,

FIGS. 16 to 18 in a side view (FIG. 16) or a top view (FIG. 17., FIG. 18) two different modifications of the plate link chain according to the invention,

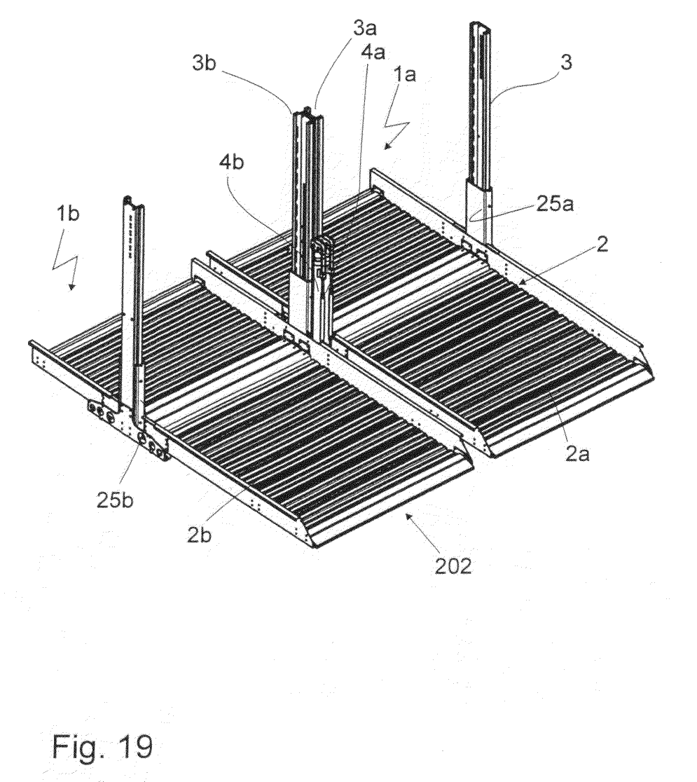

FIG. 19 in a three-dimensional view another embodiment of the storage device according to the invention,

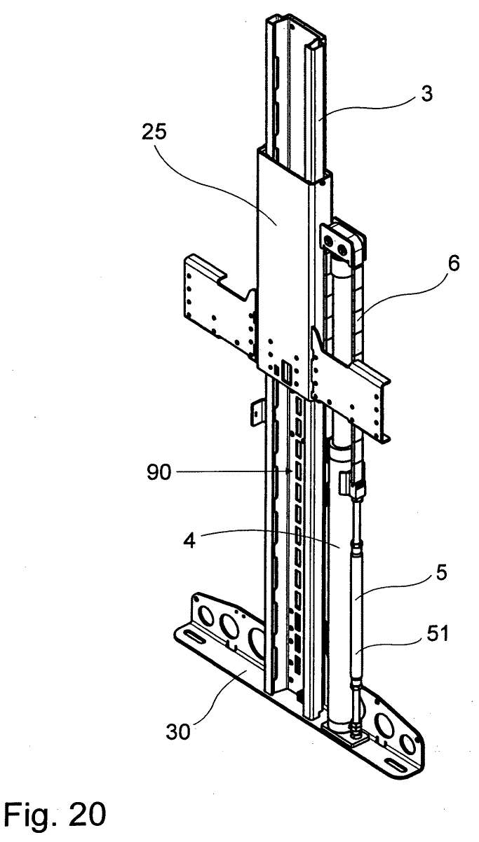

FIG. 20 in a three-dimensional view a detail of the static pillar with a base of a static pillar, motion drive and length compensation element according to the invention,

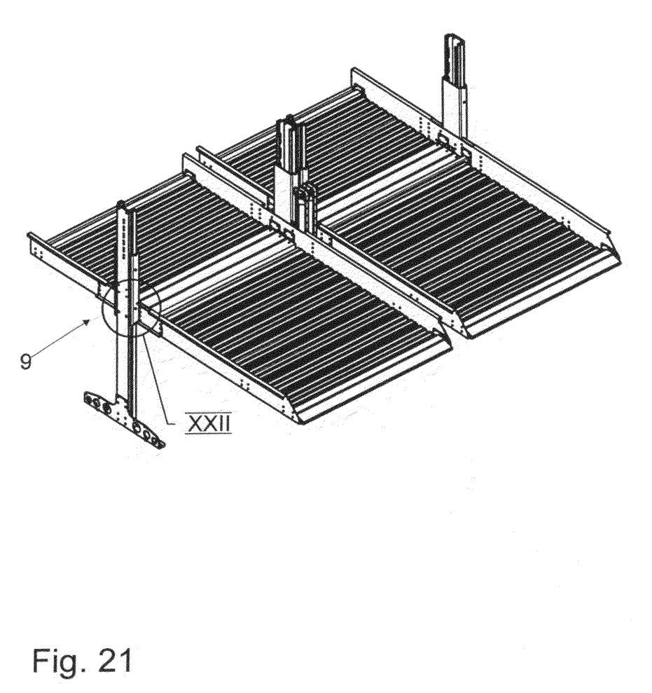

FIG. 21 in a three-dimensional view the storage device according to the invention in a drawn-up position, and

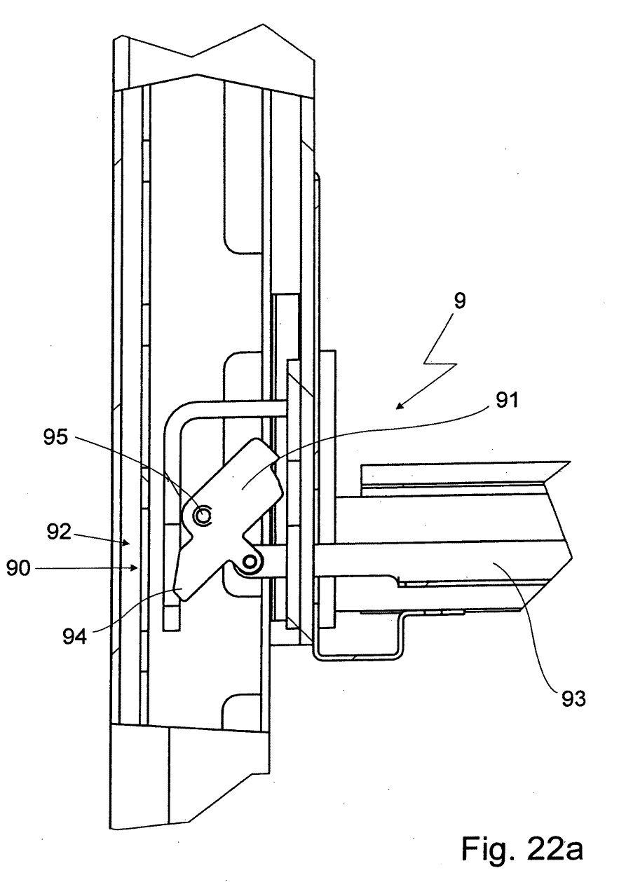

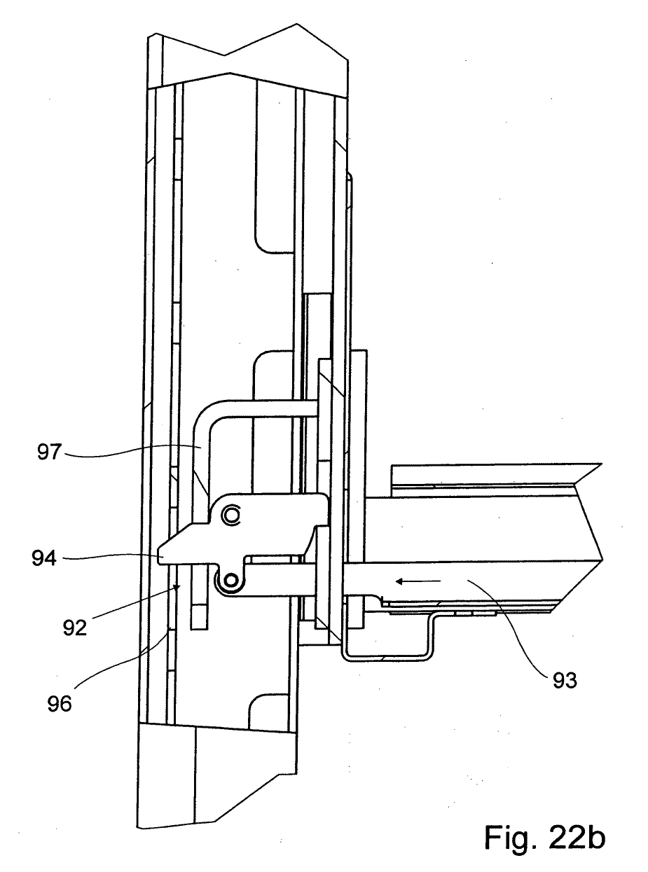

FIGS. 22a, 22b the locking device as detail according to section cutout XXII in FIG. 21 in two different positions.

In FIG. 1 a storage device according to the invention is shown in an exemplary embodiment.

The storage device 1 consists here essentially of two static pillars 3, 3′ arranged spaced apart from each other on which the platform 2 is guided. For a better guidance of the platform 2 on the static pillars 3 the platform 2 has slide-like sliding elements 25, 25′.

As it can be clearly discerned in FIG. 1 the height of the sliding elements 25 is larger than the thickness of the platform 2. The result here is a good guidance of the platform 2 on the static pillars 3 serving as guide rails.

The platform 2 consists of a (not shown) frame which is limited on the side by cheeks 29, 29′, the floor of the platform is covered by a number of parallel arranged, panel-like segment profiles. According to the stability reached by the segment profiles 28 it is possible to form the frame of the platform 2 simpler.

For lifting or lowering the platform 2 at the static pillars 3 a motion drive 4 is provided. In the embodiment shown in FIG. 1 or in FIG. 2 the motion drive 4 is designed preferably as hydraulically acting working cylinder 43.

When the working cylinder 43 provided according to the invention is pressurised the piston rod 40 is moved along the part of the double arrow 45 pointing upwards. The moving rod 40 or piston rod 40 therefore can move along the double arrow 45, the lowering movement is done, for example, by a corresponding reduction of pressure.

An essential advantage of this concept for the motion drive is the fact that with the simple acting, that is not telescope-like, working cylinder a rather high moving speed of the platform which remains the same over the entire height is reached during lifting and lowering.

The motion drive 4 comprises a moving rod 40 at the upper end of which a traction turning device 41 is provided for the traction mechanism 42. The traction turning device 41 is designed, for example, as rotating roller.

The principle of the motion drive 4 shown in FIGS. 1, 2 is deviated from the one of a simple cable pull. The arrangement with the turning roller or the traction turning device 41 has a roller moved by the moving rod with the corresponding advantages of the pulley block. The traction mechanism 42 has two ends, one of the ends being connected with the platform 2 preferably in the area of the sliding element 25. For that the lifting power is impressed in the platform 2 to lift the platform 2 accordingly.

Coming from the platform 2 first of all the traction mechanism 42 extends vertically upwards and then is deviated in a semi-circle via the traction turning device 41. On the other end, that is the end of the traction mechanism 42 opposite the platform 2, a length compensation element 5 is provided. The length compensation element 5 as well as the traction mechanism 42 is subjected to tensile stress. The length compensation element 5 is in the example shown here then attached to the stationary part of the motion drive, for example the stationary cylinder 44 of the working cylinder 43, however, also another stationary element can be at the storage device 1 or the building housing the storage device 1.

In FIG. 1, but even better in FIG. 2, the basically two-piece construction of static pillar 3 and base of the static pillar is shown. In the example shown here a multiple screw connection 39, in this case a total of six screw connections per base 30 of the static pillar are provided to connect it with the static pillar 3.

Such a modification according to the invention offers the opportunity, similar to the modular concept, to provide static pillars/bases of the static pillar-combinations of any design, at the same time large batch sizes being realised for the static pillar 3.

The particular advantages of the invention will be discussed in the further course.

In FIGS. 3 to 8 several modifications of the static pillar 3 of the storage device 1 according to the invention with different details are shown.

The embodiments shown here differ in particular with respect to the different design of a limiting device 7 for the motion length of the moving rod 40. Furthermore, FIGS. 3 to 8 show different modifications of a length adjusting device 8 of the length compensation element 5.

As the construction of the static pillar 3 in FIGS. 3 to 8 is otherwise identical this is not referred to here separately. It corresponds with the construction described already such as, for example, in FIG. 1 or 2.

In FIGS. 3 to 5 different embodiments of a limiting device 7 are shown, each in combination with a length adjustment device 8 remaining the same every time.

In the embodiment shown in FIG. 3 the limiting device 7 is designed as rod which has at its upper end a stop 70 which then blocks the lowering movement (double arrow 45 downwards) of the moving rod 40 when the receiver 46 of the traction turning device 41 is in contact with the stop 70.

In the example shown here as well as in other examples often the lowering movement or pull-back movement of the moving rod or piston rod 40 is limited at its end by the limiting device 7. It is, of course, possible to select another arrangement, namely that the upper end of the movement is limited accordingly by a stop. Basically both modifications (individual or together) are possible according to the invention.

The storage device 1 according to the invention is here designed in such a way that the lower or pulled-back position of the moving rod 40 also corresponds with the lowered position of the platform 2. Depending on the position of the stop 70 then more or less space remains for lifting, that means the resulting lifting height is set by the position of the stop 70.

Arranging is done here in such a way that the platform 2 is, for the time being, in the lowered position. The traction mechanism 42 is demounted or at least the length adjustment device 8 is opened so far that the moving rod can be lifted accordingly until the desired position of the lower end while the platform is completely lowered. The stop 70 is then accordingly calibrated to this position and the traction mechanism 42 is again mounted fixedly or the length adjustment device 8 is tensioned. Although now, for example, another stop position has been chosen for the stop 70 the platform 2 is still in the lowered position, the remaining path of movement of the moving rod leads to a suitable lifting height of the platform 2.

This way of operating is convenient in that respect that the lower end can be kept without pressure and thus now additional efforts are necessary for securing.

It has to be taken into consideration here that also the upper position of the platform 2, that is in the lifted position, may not be secured by the hydraulic drive but additional mechanic security means are provided in order to guarantee here a passive safe support of the lifted platform 2.

The limiting device 7 is designed in such a way that it can be adjusted. For that the limiting rod 71 provided in FIG. 3 has in the lower area a number of catch borings 72 interacting with corresponding counterparts in order to effect an adjustment of the position of the stop 70. The stop 70 is here at the end of the limiting rod 71 opposite the catch borings 72. The position of the limiting rod 71 can, of course, again be determined.

FIG. 4 shows another modification of the limiting device 7 arranged preferably according to the invention. The construction of the motion drive 4 is again basically similar to the one in FIG. 3, here a working cylinder 43 with a piston rod 40 as moving rod serves as motion drive 4. In the position shown here the piston rod or moving rod 40 is completely let down or lowered, the holding receiver 46 is supported on a stack of several sleeves 73, and is fixed in its further position stop-like. Here the uppermost sleeve 73′ acts like a stop as it comes in concrete contact with the receiver 46 during the lowering movement of the moving rod 40. The sleeves 73, 73′ are slid on the rod.

According to the invention it is provided that either only one sleeve 73 or also a kit (such as shown in FIG. 4) is employed. Here also the method is similar to an assembly, such as explained in FIG. 3, of course, the sleeves 73 being preferably in two pieces in order to prevent a dismantling of the working cylinder when building in the sleeves. The sleeves then are formed, for example, as half shells and can be completed with a simple screw or clamping connection accordingly, they can also be attached to or slid on the rod. Such a design can, of course, also be assembled easily by the users and is therefore user-friendly.

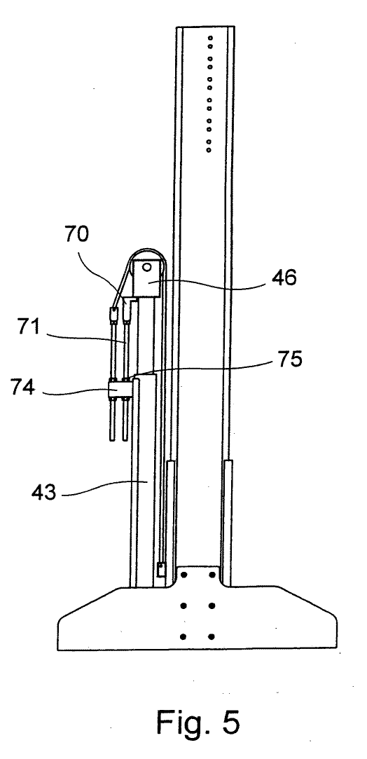

The concrete example of the limiting device 7 shown in FIG. 5 is rather similar to the one shown in FIG. 3. Here also a limiting rod 71 is designed with a stop 70, the stop 70 interacting with the lower face of the receiver 46 and forming the lower end of the movement.

In this embodiment a more precise adjusting is shown. Eventually a continuous adjusting of the limiting device 7 is possible as the limiting rod 71 is designed as threaded rod and can be fixed by one or more adjusting nuts 75 at the rest in its axial position. The rest 74 acts here at the same time as receiver for the length compensation element 5. The limiting rod 71 can be adjusted here in the direction of movement of the rod 40.

As already explained a change of the length of movement of the moving rod is connected with the corresponding change of the effective length of the traction mechanism 42.

It has to be taken into consideration here that not the complete length of the traction mechanism 42 has to be guided across the traction turning device 41 designed as roller, but a certain part does not need any flexibility in any case. This rather rigid part is collected in the length compensation element 5, cleverly this length compensation element 5 having also a length adjusting device 8 to reduce the effective length of the traction mechanism 42 accordingly for adjusting.

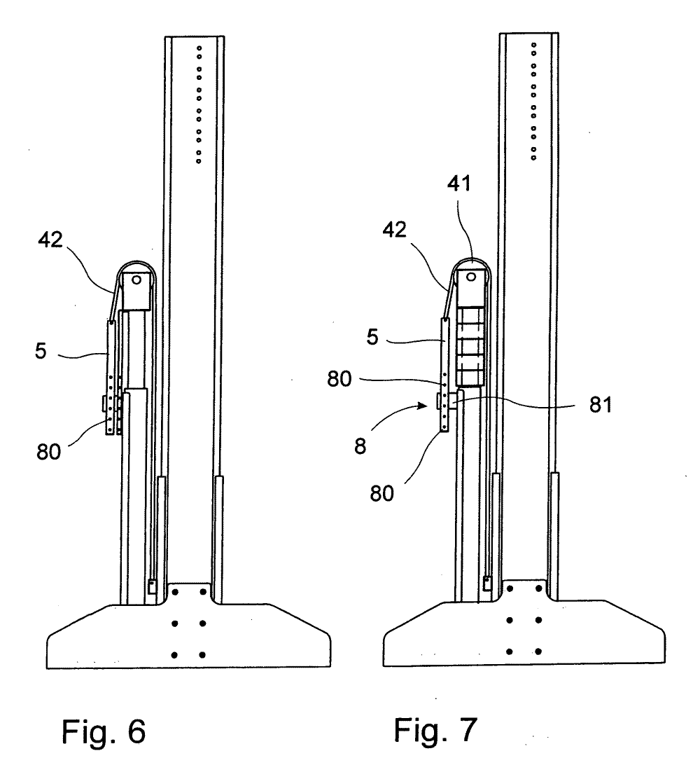

In FIGS. 3 to 5 or 6 to 8 different modifications with regard to that are shown, in the modifications of FIGS. 6 to 8 the length adjusting device 8 being formed by a number of catch borings 80 which can be connected fixedly in the suitable levels (corresponding distances of the catch borings 80 to one another) at a holding device 81. It is clear that via this connection the lifting forces have to be deducted so that a sufficiently stable mechanic design is decisive.

Besides this modification FIGS. 3 to 5 show another possible modification of the length adjusting device 8 of the length compensation element 5. In this embodiment an adjusting rod 82 is provided designed as threaded rod and which can be fixed by the suitable adjusting nuts 83 at the holding device 81 in the desired height.

The traction mechanism 42 is connected jointly in a connecting element 50. This can be realised by a suitable bolt connection. The traction mechanism 42 can be realised, for example, as wire cable, rope, chain or the like. If necessary it is provided that the connecting element 50 can be rotated around the longitudinal axis of the adjusting rod 82 so that no unnecessary torsions are imprinted in the traction mechanism 42. The rotating position can be fixed, if necessary, by a counter nut.

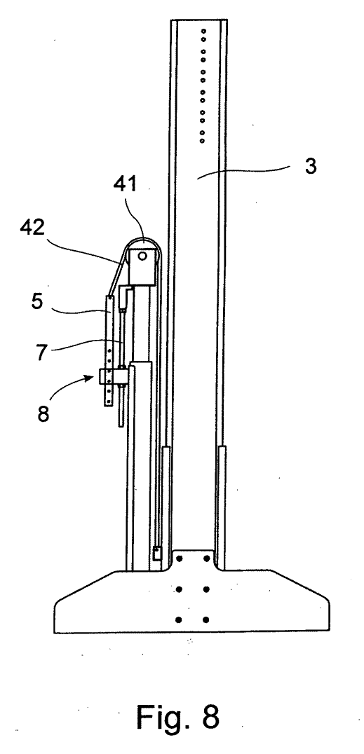

The invention is in no way limited with regard to the combination of the different limiting devices 7 and the different modifications of the length adjusting device 8 of the length compensation element 5. In this application several modifications are shown without giving here a corresponding final number. It has to be taken into consideration here that the limiting device 7 according to FIG. 6 corresponds with the one of FIG. 3, the one according to FIG. 7 corresponds with the one of FIG. 4, and the one of FIG. 8 corresponds with the one of FIG. 5.

In a preferred modification of the invention it is provided that the static pillar seen in section is formed preferably of a C- or U-shaped profile. Such a profile is characterised by a high static load.

FIG. 9 shows the storage device 1 according to the invention schematically in use. On the lifted platform 2 there is a vehicle 19. Below the first storage space 10 defined by the platform 2 thus there is a second storage space 11, on which, for example, a vehicle used for daily rides may be parked.

The platform 2 is held and guided by two static pillars 3 each arranged at the side. A motion drive 4 provided on the right hand side at the second static pillar 32 serves for lifting the platform 2. The motion drive 4 is designed here such as, for example, described in FIGS. 2 to 8.

Moving together at the platform 2 two deviation mechanisms 23, 24 are provided, the left deviation mechanism 23 being located in the area of the first static pillar 31, and the right deviation mechanism 24 in the area of the second, right static pillar 32.

The compensation traction element 20 is cleverly guided across the deviation mechanisms and extends from its first end 21 (in the upper area of the first, left static pillar 31) vertically downward to the first deviation mechanism 23, then extending further in horizontal direction below the platform 2 to the second deviation mechanism 24 in the area of the second static pillar 32, to extend from there again vertically downward parallel to the static pillar 32 and to be supported on bearings at the second end 22.

It has to be taken into consideration that the pivot of the second deviation mechanism 24 designed as roller is located below the horizontally extending part of the compensation traction element 20, in contrast to that the rotating axis of the first deviation mechanism 23 also designed a rotating roller is located above the compensation traction element 20.

As shown in FIG. 9 the compensation traction element 20 extends below the platform 2 without limiting the invention to this. Of course, it is also possible to arrange the compensation traction element in a suitable way on the upper side of the platform 2 or housed inside the platform 2, that means protected. All modifications mentioned before are part of the invention.

The way of functioning of the storage device according to the invention is as follows.

First of all the platform 2 is in the lowered position (not shown in FIG. 9, here better in FIG. 1), in order to put the front end 27 of the platform on the floor in such a way that a vehicle or another good can enter the platform.

Then the motion drive 4 is activated, for example the hydraulic acting working cylinder 43 is pressurised in such a way that the piston rod 40 is moved upward. The moving rod 40 does not engage directly with the platform 2, for that a separate traction mechanism 42 is provided.

It will be described how this traction mechanism 42 is designed preferably.

The piston rod 40 carries at its upper end, held in a receiver 46, the traction turning device 41 designed as deviation roller. The principle of the moved roller leads to a corresponding deviation of the traction mechanism 42 with corresponding consequences, as they are known from the cable pull. Here the length of the traction turning device 42 is constant, the speed of the lifting platform 2 is twice the speed of the pulling-out piston rod 40.

The traction mechanism 42 engages at the platform, preferably at the sliding element 25 of the platform, if possible near the deviation mechanism 24 at it keeping possible tilting moments and so on very low.

It is an object of the invention to provide, with as little effort as possible for the motion drive, a reliable drive, that means a drive which does not lead to jamming or tilting of the platforms loaded with up to 2.5 tons or more. Tilting or jamming of the platform 2 occurs as a risk in particular when the synchronous qualities of the platform 2 differ at the two parallel arranged static pillars 31, 32. In order to avoid this the compensation traction element 20 is provided. Here the load of the platform 2 is supported through the left deviation mechanism 23 on the compensation traction element 20, and is deviated through the first end in the first, left static pillar 31. At the right hand end of the platform the traction mechanism engages directly at the platform, and transfers here the forces in the construction, here in the right, second static pillar 32.

The advantage of the compensation traction element is in particular that this is an element which can be manufactured economically, and which is maintenance-free and reliable.

In FIG. 10 the principle of the storage device 1 according to the invention of FIG. 9 is again shown schematically. By means of the flexibility of the compensation traction element 20 which allows a suitably flexible angling (double-L-like, opposite angled at the respective deviation mechanisms 23, 24) at each point, the synchronous qualities of the platform 2 are guaranteed over the complete lifting height.

An essential part of the present invention is the high variability of the storage device according to the invention in order to realise advantages with large batch sizes in the production costs.

An parameter in storage devices is the width of the platform 2. By means of the width of the platform 2, of course, the distance of the two static pillars 31, 32 changes and thus also the respective length of the compensation traction element 20 changes.

However, the invention suggests here a new concept leading to the fact that with a compensation traction element a number of different types of widths of the storage device can be realised. This is shown, for example, in FIGS. 11, 12, or supplementing to that also in FIG. 3 or 1.

At this point it is referred to the connecting points 300 arranged in the upper area, preferably of the first static pillar 31. The connecting points 300 can be provided, of course, also at the second static pillar 32, here preferably in the lower region.

It has to be taken into consideration that cleverly the compensation traction element 20 ends in the area of the right, second static pillar 32 in the lower area, and next to this second static pillar 32 also the motion drive 4 is provided.

Cleverly the compensation traction element 20 is connected to the static pillar on the bottom to which also the traction mechanism 42 is joined at the platform.

The row of connecting points 300 is shown in FIGS. 11, 12 in an enlarged detail. The distance of the single connecting points 300 to one another corresponds with the distance of the different width modifications of the platform 2.

In order to be able to carry out the width adjusting simply the compensation traction element 20 has at its first end 21a suitably designed connecting element 26 which is introduced in a suitable way in the connecting point 300 and can be fixed there. If necessary the connecting element 26 is also held by a screw connection in the connecting point 300 securely and fixedly.

Below the connecting element an adjusting area 200 for a precise length adjusting is connected. Below here there is a coupling element 201 for a flexible connection with the compensation traction element 20.

In the embodiment shown here the connecting points 300 are realised in the upper area of the static pillar 31, however, according to the invention it is also possible that the connecting points 300 are provided also in the lower area of the static pillar 3, for example at the second static pillar 32. Of course, the arrangement on the upper area is more convenient for assembly purposes. Basically both modifications can be combined with each other.

In FIGS. 13, 14 two different modifications of the base 30 of the static pillar 30 according to the invention are shown.

In this respect the invention is also characterised by a high variability in the design of the base 30 of the static pillar, when otherwise the construction of the static pillar 3 remains the same. Instead of the otherwise known one-piece design of the base 30 of the static pillar with the static pillar 3 it is now suggested according to the invention that the base 30 of the static pillar is designed as individual, separate component and is selected according to the concrete requirements to be then connected with a static pillar 3 which can otherwise be manufactured in large batch sizes.

For the stable, statically stressed connection of the static pillar 3 with the base 30 of the static pillar a single or, as shown here, multiple screw connection 39 is provided.

It is clear that through this connection the complete load of the arrangement with the parked vehicle is deviated and here a corresponding stability has to be reached.

In FIGS. 13, 14 two different modifications are shown where in FIG. 13 an asymmetric shape of the base 30 of the static pillar is shown, the right part 33 of the base 30 of the static pillar being clearly longer than the left part 34. The result is, of course, a higher stability as the floor space of the base 30 is larger than, for example, in the modification according to FIG. 14. The right part 33 extends here in the direction of the front end 27 of the platform 2 which can be traveled on.

Because of the raised floor space according to the modification of FIG. 13 a static pillar 3 designed this way or storage device 1 is suitable to be set up with very low additional effort for assembly or anchoring. Of course, this is convenient if the underground is suitable.

In the second modification shown in FIG. 14 a symmetric base 30 of the static pillar is suggested the floor space of which is smaller than the one in the modification of FIG. 13, and can be attached to the base of floor slab preferably with additional anchoring means, for example ground anchors, screw anchors, screw-peg combinations and so on. Of course, a symmetric base also can be realised larger than the suggestion according to FIG. 13.

In FIG. 15 this is again shown schematically, the base 30 of the static pillar is designed essentially in the view L-shaped, the limb extending upward having the openings (borings) for the screw connection 39. Accordingly, the static pillar 3 has openings 39′ interacting with it for putting through the screws or other connecting means. In order to produce a connection as stable as possible between the static pillar 3 and the base 30 of the static pillar, additionally an arrangement is chosen in order to prevent torsions if possible. This is reached by a positive locking interaction of the static pillar 3 with the base of the 30 of the static pillar, here the static pillar 3 having in the bottom area a nose or shoulder 38 which can be put in suitable slots 37 in the horizontally extending limb of the base 30 of the static pillar. At this limb furthermore also fastening openings 301 are provided for anchoring elements and the like.

Another positive interlocking interaction is effected by the beaded edge 36 in the center area of the base 30 of the static pillar which is designed engaging positive interlocking in a suitable recess 35 in the lower area of the static pillar 3.

The invention furthermore comprises also a plate link chain which is used in particular also for a storage device for vehicles as described. It has to be taken into consideration here that this plate link chain is not characterised only for this particular case of application, but has to be protected also itself, and the applicant has also the intention to do it. The plate link chain described in the following is employed here in the storage device described before as a traction mechanism interacting with the motion drive, and/or as compensation traction element extending below or at the platform ending at the static pillar.

The view of the plate link chain 6 is shown in FIG. 16.

FIGS. 17 and 18 each show in a top view two different modifications of this plate link chain 6 according to the invention.

The plate link chain 6 consists here of a number of chain links 60, 60′ each connected flexibly by pins 61 with one another.

The single chain links 60 consist of a number of plates arranged parallel to each other, the plates 62 being preferably identical to one another.

For increasing the stability of the plate link chain according to the invention the plates are arranged double as double plates, as it can be seen clearly, for example, in FIG. 18 in the area of the end chain link 63. Here simply two identical plates 62 are placed one beside the other with their complete surfaces, these two plates 62 belonging to the same chain link 60.

For joining purposes of the plate link chain the plates 64 of the end chain link 63 are designed larger or longer than the plates 62 of the other chain links 60.

The difference between the modification according to FIG. 18 and the modification according to FIG. 17 is that in FIG. 17 eight plates 62 (four double plates) are provided per chain link 60 and in FIG. 18 six plates (three double plates) are provided.

Besides a division of the six plates per chain link in three double plates, of course, also the modification is realised that in the center two double plates are provided which are covered outside by one exterior plate each. In the modification with eight plates then three double plates are arranged in the center which each being covered by a single exterior plate.

The plate link chain 6 according to the invention shown here which is also referred to as flyer chain is characterised by a very high breakage force while the thickness is low and the division (distance of the pins 61) is small.

Preferably it was provided according to the invention that the division of the chain links is 14 to 17 mm. In particular an interval of 15.6 to 16 mm is provided, in the example shown in FIGS. 16, 17 and 18 the division is about 15.87 mm.

The thickness of the plate link chain is preferably at least mm, in particular preferably 12 mm to 18 mm. In the embodiment shown in FIG. 18 the thickness d of the plate link chain is about 15 mm or 15.1 mm.

According to the invention it has been found here to be convenient for the ratio of width of the chain to thickness of the chain to be less than 3, in particular a ratio of 1.9 to 2.8 is suggested. Such a chain is characterised by a high stability, that means high tension forces with at the same time small dimensions and small bending angle radii. The width of the chain varies here for example from about 28 to about 42 mm.

A pin diameter or a pin thickness of at least 4.5 mm is preferred here. Preferably 5 mm to 7 mm, in particular preferably 5.8 to 6.2 mm are suggested, the pins shown in FIGS. 17, 18 have a diameter of about 5.95 mm.

Plate link chains or flyer chains designed this way have a breakage force of at least 100 kn (according to embodiment of FIG. 18), or at least 156 kn for the example according to FIG. 17 with a width of the plate link chain of only about 31.5 mm (FIG. 18), or about 41.1 mm (FIG. 17).

The arrangement shown in FIG. 19 corresponds in large parts with the one in FIG. 1 only with the difference that here two storage devices 1a and 1b are arranged one beside the other. The motion drives 4a, 4b of the two storage devices 1a, 1b are here located in the center “back to back”. This Fig. shows the high flexibility of the construction and manufacturing as, according to the design of the pillars 3a, 3b or the sliding elements 25a, 25b it is not decisive whether the motion drive is arranged on a platform or storage device on the left or right pillar. Thus it is easily possible to adapt the storage device according to the invention for example to vehicles with left-hand drive or right-hand drive, which can be done completely without any additional components.

Furthermore the invention is free with regard to the arrangement of the motion drive 4, 4a, 4b in front of or behind the pillar 3, 3a, 3b (relative to the direction 202 of entering). In the modification according to FIG. 1 the motion drive 4 is arranged in this regard on the backside of the static pillar 3, in the modification according to FIG. 19 in front of it. The motion drive 4, in particular the working cylinder 43, thus is provided between the entering area 202 of the platform 2 and the static pillar 3.

In FIG. 20 the combination of the static pillar 3 with the base 30 of the static pillar is shown. In the example shown here it has to be pointed out in particular that the motion drive 4, realised by the working cylinder 43, as well as the length compensation element 5, realised by the turnbuckle 51, is supported on the horizontally extending part of the L-shaped base of the static pillar. If necessary, a suitable reinforcement plate is arranged, a minimum distance between these two elements reduces the occurrence of bending moments, the minimum distance is the result of the respective width of these components.

In a preferred modification of the invention it is provided that the limiting device 7 is the self-locking of the working cylinder 43. A separate arrangement of a limiting device 7, as for example shown in FIG. 20, is not decisive, this is reached by a suitable dimensioning of the working cylinder.

FIG. 21 shows in a detail circle XXII where the locking device 9 is arranged basically, this is explained in more detail in FIGS. 22a, 22b. In the static pillar 3 (see also FIG. 20) a locking catch 90 is provided. This locking catch extends over a wide range of the height of the static pillar 3.

In FIG. 22a the locking catch 90, which is here realised by a channel of punched holes 92, is also shown. In the position shown in FIG. 22a the locking element designed as locking ratchet 91 is drawn back by the connecting rod 93 in such a way that the front area 94 does not engage in the whole 92. In this position of the connecting rod 93 or the ratchet 91 which is supported on bearings rotating around a horizontal axis 95 the platform 2 can be lowered. The position of the connecting rod shown here is reached by a magnet which is current-fed.

FIG. 22b shows the locked condition. The connecting rod 93 is shifted to the left in such a way that the front area 94 of the ratchet 91 projects in the hole 92 and prevents a lowering movement at the edge 96 (the magnet is currentless, the locking is in place!). Thus the locking position is defined, a suitably massive supporting angle 97 keeps the locking ratchet in the locking position as the ratchet 91 is in contact with the angle 97.

The claims filed with the application now and to be filed later on are attempted formulations without prejudice for obtaining broader protection.

If here, on closer examination, in particular also of the relevant prior art, it turns out that one or the other feature may be convenient for the object of the invention, however, not decisively important, of course, already now a formulation is striven for which does not contain anymore such a feature, in particular in the main claim.

References in the sub-claims relate to the further design of the matter of the main claim through the characteristics of the respective sub-claim. These are, however, not to be understood of a waiver of independent protection of the matter for the characteristics of the referred sub-claims.

Characteristics only disclosed in the description so far may, in the course of proceedings, be claimed as being of inventive relevance, for example to distinguish from the state of the art.

Characteristics only disclosed in the description or even single characteristics of claims comprising a number of characteristics may be taken over in the first claim at any time to distinguish from the state of the art, and this is even if such characteristics have been mentioned in connection with other characteristics, and achieve particularly convenient results in connection with other characteristics, respectively.

1-52. (canceled)

53. A device for storing vehicles, goods or the like with several storage spaces, at least one space being arranged on a lifting or lowering platform, the platform being guided on at least one static pillar and a motion drive being provided for the platform, characterised in that the motion drive has a traction turning device on a movable rod for a traction mechanism, and one end of the traction mechanism is applied to the platform, and the traction mechanism has a length compensating element.

54. The storage device for storing vehicles, goods or the like with several storage spaces, at least one storage space being arranged on a lifting or lowering platform, the platform being guided on at least one static pillar, and a motion drive being provided for the platform, in particular according to claim 53, characterised in that at, in particular below, the platform between two static pillars a compensation traction element is arranged, the first end of the compensation traction element is arranged at the first static pillar, and the second end of the compensation traction element is arranged at the second static pillar, and the compensation traction element is deviated by deviation mechanisms arranged at the platform, a static pillar having a number of connecting points for the compensation traction element, and through the selection of the connecting point the width of the platform can be adjusted while the total length of the compensation traction element remains the same.

55. The storage device according to claim 53, characterised in that by changing the active length of the length compensation element the final position of the lifted platform can be adjusted to the level of the good, for example the vehicle, which is stored on the platform, and/or at the static pillar a releasable locking device is provided which effects that the platform remains in the desired locking position at the static pillar independently from motion drive or traction mechanism.

56. The storage device according to claim 53, characterised in that a locking position of the locking device relates to each final position of the lifted platform set by the change of the effective length of the length compensation element, and/or the in-use storage device the lifted platforms of which are in a first final position can be brought in a second, new final position by changing the effective length of the length compensation element, the platform being able to be loaded in either final position, and/or the traction mechanism is connected jointly to the length compensation element.

57. The storage device according to claim 53, characterised in that the length compensation element is designed rigid and/or rod-like, and/or the length compensation element is supported on bearings on the static pillar, on the base of the static pillar, on the floor or a wall or the stationary part of the motion drive, and/or the motion drive, in particular the working cylinder is supported on the base of the static pillar.

58. The storage device according to claim 53, characterised in that a distance as small as possible of the length compensation element supported on the base of the static pillar and the motion drive supported on the base of the pillar is provided, and/or the length compensation element has a length-adjusting device, and/or the length compensation element is designed as threaded rod, and a nut the position of which on the threaded rod can be changed is the length adjusting device, and/or the length compensation element is designed as turnbuckle.

59. The storage device according to claim 53, characterised in that the length compensation element is designed as catch rod, the catch rod having a number of catches which can connect fast in the desired position with a support stationary compared with the device, and/or a length-adjusting device supported by an actuating drive is provided, and/or along the static pillar a locking catch is provided in which a locking element of the locking device engages in a holding way.

60. The storage device according to claim 53, characterised in that the locking device is formed by a channel of punched holes in the static pillar in which an operating locking ratchet engages, and/or the motion drive, in particular the working cylinder, is provided between the entrance area of the platform and the static pillar, and/or the lowest storage space is below the lowest movable platform.

61. The storage device according to claim 53, characterised in that the storage spaces are arranged one above the other, and/or the platform comprises a sliding element, and the sliding element is guided on the static pillar, and the traction mechanism engages in the sliding element, and/or the two facing static pillars carrying the platform together and the sliding elements moving on it are similar.

62. The storage device according to claim 53, characterised in that as motion drive a preferably hydraulically acting working cylinder is provided, the piston rod of which serves as moving rod or acts on a moving rod, or as motion drive a motor, in particular an electro-motor and a spindle is provided, and at least one area of the spindle serves as moving rod or acts on a moving rod, and/or a limiting device for the motion length of the moving rod is provided.

63. The storage device according to claim 53, characterised in that the limiting device defines at least one end of the movement of the moving rod, and/or the limiting device is set by the self-locking of the working cylinder, and/or an adjustable limiting device to set the motion length or the position of the end is provided.

64. The storage device according to claim 53, characterised in that the limiting device is designed as a stop for the rod of which in particular the position and/or length can be changed, and/or the limiting device is designed as a sleeve slid on the rod, and/or the position of the traction turning device on the rod can be set, and/or the limiting device acts on the position of the traction turning device.

65. The storage device according to claim 53, characterised in that the traction turning device is designed as rotating roller, and/or a manually adjustable or operated limiting device is provided, and/or the limiting device has an actuating drive which can be positioned in selected positions, and/or the first end of the compensation traction element can be connected in the upper area of the first static pillar, at least above the lifted position of the platform, with the first static pillar.

66. The storage device according to claim 53, characterised in that the second end of the compensation traction element is connected in the lower area of the second static pillar with the second pillar, and/or the first static pillar has in the upper area the connecting points, and/or the static pillar has U- or C-shaped section.

67. The storage device according to claim 53, at least one storage space being arranged on a lifting or lowering platform, the platform being guided on at least one static pillar and a motion drive being provided for the platform and the platform having a minimum carrying power of 19 kn, characterised in that as traction mechanism interacting with the motion drive and/or as compensation traction element extending below or on the platform ending at the static pillar a plate link chain consisting of a number of chain links each of which being connected jointly to each other by pins is provided, and each chain link having between one and nine plates, preferably between four and eight plates.

68. The storage device according to claim 53, characterised in that as deviation mechanism a deflection roller is provided, and/or the ratio between diameter of the deflection roller and the separation of the chain is less than 5, in particular less than 4.7, preferably between 3.5 and 4, and/or the ratio between diameter of the deflection roller and thickness of the chain is less than 6, in particular less than 5.5, preferably between 3.7 and 4.3, and/or a diameter of the deflection roller of 50 to 75 mm, preferably of 55 to 65 mm, is provided.

69. The device according to claim 53, characterised in that the plate link chain consists of a number of chain links each connected jointly to another by pins, the plate link chain having at least four plates per chain link and a breakage force of at least 60 kn, preferably at least 100 kn, and/or a separation of the chain links of at least 13 mm, preferably 14 to 17 mm, in particular 15.6 to 16 mm, is provided, and/or a thickness of the plate link chain of at least 11 mm, preferably 12 to 18 mm, in particular about 14.8 to 15.3 mm, is provided, and/or a thickness of the pin of at least 4.5 mm, preferably 5 to 7 mm, in particular 5.8 to 6.2 mm, is provided, and/or the ratio between the thickness of the chain and the diameter of the pin of at least 2.4, preferably 2.41 to 2.7, preferably 2.47 to 2.6 is provided and/or the ratio between the width of the chain and the thickness of the chain is less than 3, in particular about 1.9 to 2.8.

70. The device for vehicles, goods or the like with several storage spaces, at least one storage space being arranged on a lifting or lowering platform, the platform being guided on at least one static pillar, and a motion drive for the platform being provided, in particular according to claim 53, characterised in that on the static pillar a base of the static pillar is provided which is a component independent from the static pillar and which may be exchanged, if necessary.

71. The device according to claim 53, characterised by a single or multiple screw connection between static pillar and base of the static pillar, and/or positive locking interaction of static pillar and base of the static pillar when base of the static pillar and static pillar have been assembled.

72. The device according to claim 53, characterised in that an essentially symmetric construction of the base of the static pillar is provided, and/or the base of the static pillar has fastening openings for putting through of fastening means such as screw anchors and so on, and/or an asymmetric construction of the base of the static pillar is provided, the longer area of the base of the static pillar is arranged in the direction of the entrance area of the platform at the pillar.
